(19) United States
(12) Patent Application Publication
(10) Pub. No.: US 2024/0356372 A1
(43) Pub. Date: Oct. 24, 2024

(54) WIRELESS COMMUNICATION AND CHARGING DEVICE

(71) Applicant: STMicroelectronics International N.V., Geneva (CH)

(72) Inventors: Jean-Louis DEMESSINE, Saint-Jeannet (FR); Hughes CREUSY, Aix en Provence (FR); Renaud LEMONNIER, Antibes (FR)

(73) Assignee: STMicroelectronics International N.V., Geneva (CH)

(21) Appl. No.: 18/636,829

(22) Filed: Apr. 16, 2024

(30) Foreign Application Priority Data
Apr. 21, 2023 (FR) 2304052

(51) Int. Cl. H02J 50/10

(52) U.S. Cl. CPC H02J 50/10

(57) ABSTRACT

A wireless communication device receives power in wireless fashion from another wireless communication device. A charging circuit of the wireless communication device is configured to charge a power storage device. A communication circuit of the wireless communication device is configured to communicate information relative to the charging of the power storage device to the other wireless communication device. To accomplish this, the communication circuit includes a wireless communication transponder and a switch coupled to a first terminal of the transponder, wherein the open and closed state of switch is controlled by the charging circuit.

### PRIORITY CLAIM

This application claims the priority benefit of French Application for U.S. Pat. No. 2,304,052, filed on Apr. 21, 2023, the content of which is hereby incorporated by reference in its entirety to the maximum extent allowable by law.

### TECHNICAL FIELD

The present disclosure generally concerns wireless communication devices, for example using a technology of radio frequency identification (“RFID”) type, or of near-field communication (“NFC”) type, and, in particular, wireless communication devices adapted to a wireless charging using a wireless communication technology.

### BACKGROUND

RFID communication is a wireless communication technology which enables to detect and to identify a transponder, generally attached to an object. An RFID system generally comprises an RFID reader, and an RFID transponder (contraction of the words “transmitter” and “responder”), for example a tag. Typically, the RFID reader is configured to send a polling signal, generally a radio frequency signal, to the RFID transponder, which can then answer the RFID reader. According to the implemented electronic devices, the RFID communication may be established at low frequency, for example between 125 and 134 kHz, at high frequency (HF), for example around 13.56 MHz, at ultra-high frequency (UHF), for example between 860 and 960 MHz, or even at super-high frequency, for example around 2.45 GHz. A high frequency favors an exchange of information (between the reader and the transponder) at higher rates than at low frequency, and at a greater distance.

Near-field communication (NFC) is a wireless communication technology, which can be seen as an extension of RFID, and which allows a communication over a short distance, generally up to 1 m, for example up to 10 cm, between electronic devices, for example between an NFC reader, which may also be designated as “poller”, and an NFC transponder, which may also be designated with the term “listener”, for example a tag.

NFC technology is a standardized open technological platform, for example in standards ISO/IEC 18092 and ISO/IEC 21481, and incorporates many already-existing standards such as for example the type-A and type-B protocols defined in standard ISO-14443, which may be communication protocols usable in NFC technology.

NFC technology may also be used in an RFID transponder, for example an RFID transponder compatible with standard ISO/IEC 15693 and/or standard ISO/IEC 18000-3.

Thus, a wireless communication transponder, for example RFID or NFC, is an electronic device capable of exchanging information in wireless fashion via an antenna with a reader, for example RFID or NFC, according to a wireless communication protocol, for example a protocol compatible with the NFC technology.

During a transmission of information between a reader and a transponder, an antenna of the reader may emit an electromagnetic field, or radio frequency signal (RF), for example at 13.56 MHz for the NFC technology, or at other frequencies for the RFID technology. The generated radio frequency signal, the carrier, generally is a sine wave.

For a transmission of information from the reader to the transponder, the reader may implement a modulation/demodulation circuit to modulate the carrier. The transponder comprises an antenna for receiving the radio frequency signal and a demodulation/modulation circuit configured to demodulate the received carrier to obtain the data transmitted by the reader. The carrier may also be used to supply in wireless fashion a quantity of electric power, generally relatively limited, for example a power ranging up to 1 W, or even up to 3 W, to the transponder, as detailed hereafter.

For a transmission of information from the transponder to the reader, the latter may generate the radio frequency signal (the carrier) with no modulation. The transponder antenna can then modulate, or retromodulate, the radio frequency signal generated by the reader, according to the information to be transmitted to the reader. The frequency of this modulation corresponds, for example, to a sub-carrier of said carrier. The frequency of this sub-carrier depends on the communication protocol used and may be, for example, equal to 848 KHz.

A plurality of operating modes are then possible, particularly according to the type of transponder: a passive mode, a semi-active mode, or an active mode.

In the passive mode, the so-called passive transponder can retromodulate the radio frequency signal originating from the reader to transmit information thereto, but does not integrate, for the transmission of the information, transmission circuitry capable, for example, of generating its own electromagnetic field. Generally, a passive transponder comprises no power supply since it can use the electromagnetic field originating from the reader to power its electronic components. However, in certain applications, the passive transponder may incorporate a power supply, for example a battery.

In the semi-active mode, the transponder uses the power of the reader to answer thereto. Thus, a so-called semi-active transponder acts as a passive transponder at the wireless communication level. However, electronic components of the transponder, for example a microcontroller, and/or a memory, may use the power of a battery.

In the active mode, the reader and the so-called active transponder can both generate an electromagnetic field. Generally, this operating mode is used when the active transponder is provided with a specific power source, typically a battery.

As compared with a passive mode, in the semi-active mode, and more in the active mode, more significant communication distances can be obtained, which may range up to several tens of centimeters, for example according to the communication protocol used, to the size of the reader antenna, and/or the sensitivity of the reader.

In the semi-active or active mode, the battery of the transponder can be charged by wireless power transfer, by converting the electromagnetic field received from the reader into a charge current in the transponder.

Wireless power transfer (“WPT”), or wireless charging (“WPC”), enables to transfer in wireless fashion the power from a transmitter to a receiver, for example to recharge a battery of the receiver. The wireless charging is generally based on an electromagnetic coupling between an antenna of the transmitter adapted to being coupled to an antenna of the receiver, the power transfer relying on an electromagnetic field emitted by the antenna of the transmitter and captured by the antenna of the receiver.

The wireless power transfer, or wireless charging, may be performed by using a wireless communication technology, for example of RFID or NFC type. This can be referred to as an RFID charge or of an NFC charge. In this case, the electromagnetic field at the given frequency, for example at 13.56 MHz for NFC, is used for: wireless communications in reader mode or in transponder mode; and wireless charging in transmitter mode or in receiver mode, where the RFID or NFC reader is that which supplies power to the RFID or NFC transponder.

For example, the NFC Forum defines, in the section “NFC Forum wireless charging”, criteria of wireless charging, called WLC, by using the NFC technology.

There exists a need for a solution, preferably simple and easy to implement, for controlling a wireless power charging in a wireless communication device, comprising a wireless communication transponder, for example a RFID or NFC transponder.

There also exists a need for a solution, preferably simple and easy to implement, to have information relative to a charge level in a wireless communication device comprising a transponder, for example a RFID or NFC transponder, for example to transmit the charge level to another wireless communication device comprising a reader.

There is a need to overcome all or part of the drawbacks of known wireless communication and charging devices.

### SUMMARY

An embodiment provides a wireless communication device configured to receive power in wireless fashion from another wireless communication device, the wireless communication device comprising: a charging circuit configured to charge a power storage device; a communication circuit configured to communicate a charging information relative to the charging of the power storage device to the other wireless communication device, and comprising: a wireless communication transponder; and a switch coupled to a first terminal of the transponder, and controlled by the charging circuit.

According to an embodiment, the switch is configured to couple or not the first terminal and a node of application of a voltage, said node being included in the communication circuit, according to a control of the charging circuit, corresponding to the charging information to be communicated.

According to an embodiment, the communication circuit, for example the transponder, is configured to detect whether the first terminal and the node are coupled or in open circuit, and to transmitting the corresponding charging information to the other wireless communication device.

According to an embodiment, the switch is configured to couple the first terminal and the node when the charging circuit controls the turning on of said switch and/or to opening the circuit between the first terminal and the node when the charging circuit controls the turning off of said switch.

According to an embodiment, the charging circuit is configured to couple, via the switch, the first terminal and the node when the power storage device passes from a first charging state to a second charging state, and/or to opening, via the switch, the circuit between the first terminal and the node when the power storage device passes from the second charging state to the first charging state.

According to an embodiment, the control of the charging circuit is a control signal having: a first state indicating a first charging state of the power storage device, the first state being intended to trigger, or maintain, the opening of the circuit between the first terminal and the node; and a second state indicating a second charging state of the power storage device, the second state being intended to trigger, or maintain, the closing of the circuit between the first terminal and the node.

According to an embodiment, the first charging state is a non-completed charging state, and the second charging state is a completed charging state.

According to an embodiment, the transponder comprises a processing unit configured to detect whether the first terminal and the node are coupled or in open circuit.

According to an embodiment, the processing unit comprises a circuit configured to measure a voltage present at the first terminal.

According to an embodiment, the processing unit comprises comparison means configured to compare the voltage measured at the first terminal with the voltage present at the node to detect whether the first terminal and the node are coupled or in open circuit.

According to an embodiment, the switch is configured to couple or not the first terminal and a second terminal of the transponder according to a control of the charging circuit, corresponding to the charging information to be communicated.

According to an embodiment, the communication circuit, for example the transponder, is configured to detect whether the first and second terminals are coupled or in open circuit, and to transmitting the corresponding charging information to the other wireless communication device.

According to an embodiment, the switch is configured to couple the first and second terminals when the charging circuit controls the turning on of said switch and/or to opening the circuit between the first and second terminals when the charging circuit controls the turning off of said switch.

According to an embodiment, the charging circuit is configured to couple, via the switch, the first and second terminals when the power storage device passes from a first charging state to a second charging state, and/or to opening, via the switch, the circuit between the first and second terminals when the power storage device passes from the second charging state to the first charging state.

According to an embodiment, the control of the charging circuit is a control signal having: a first state indicating a first charging state of the power storage device, the first state being intended to trigger, or maintain, the opening of the circuit between the first and second terminals; and a second state indicating a second charging state of the power storage device, the second state being intended to trigger, or maintain, the closing of the circuit between the first and second terminals.

According to an embodiment, the first charging state is a non-completed charging state, and the second charging state is a completed charging state.

According to an embodiment, the transponder comprises a processing unit configured to detect whether the first and second terminals are coupled or in open circuit.

According to an embodiment, the processing unit comprises a circuit configured to measure a voltage present at the first terminal and to delivering a reference voltage into the second terminal.

According to an embodiment, the processing unit comprises comparison means configured to compare the voltage measured at the first terminal with the reference voltage, to detect whether the first and second terminals are coupled or in open circuit.

According to an embodiment, the charging information takes the form of a binary value.

According to an embodiment, the transponder comprises a storage unit configured to store the charging information.

According to an embodiment: the first terminal is an input terminal of the transponder; and/or the power storage device is a battery; and/or the power storage device is used for the wireless communication device, and/or to charge an object coupled to said wireless communication device, for example a connected object; and/or the transponder is in the form of an integrated circuit.

According to an embodiment, the wireless communication device further comprises a wireless communication antenna coupled to the transponder and configured to transmit the charging information by electromagnetic coupling with another wireless communication antenna of the other wireless communication device, the charging circuit being also coupled to the wireless communication antenna.

According to an embodiment, the transponder is an NFC transponder or an RFID transponder, for example an RFID transponder using an NFC technology.

An embodiment provides a method of communication of a charging information relative to the charging of a power storage device comprised in a wireless communication device adapted to receive the power in wireless fashion from another wireless communication device, the wireless communication device comprising: a charging circuit configured to charge the power storage device; and a communication circuit comprising: a wireless communication transponder; and a switch coupled to a first terminal of the transponder, and controlled by the charging circuit; the switch being configured to couple or not the first terminal to a second terminal of the transponder, or to a node of application of a voltage, said node being included in the communication circuit, according to a control of the charging circuit, corresponding to the charging information to be communicated; the method comprising: the detection, by the communication circuit, of a coupling or of an open circuit between the first and second terminals, or between the first terminal and the node; and the transmission, by the communication circuit, of the corresponding charging information to the other wireless communication device.

According to an embodiment, the detection and/or the transmission is performed by the transponder.

According to an embodiment, the method further comprises, before the detection:
the sending of a control signal from the charging circuit to the switch, corresponding to the charging information, so as to couple, or open the circuit between, the first and second terminals or the first terminal and the node.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows in the form of a circuit block diagram an example of a wireless communication system also supporting wireless charging;

FIG. 2 schematically shows in the form of a circuit block diagram an example of a wireless communication system comprising a wireless communication device according to an embodiment;

FIG. 3A schematically shows in the form of a circuit block diagram an example of embodiment of the wireless communication device of FIG. 2, including a wireless communication transponder;

FIG. 3B schematically shows in the form of a circuit block diagram another example of embodiment of the wireless communication device of FIG. 2, including another wireless communication transponder;

FIG. 4 schematically shows in the form of a circuit block diagram an example of embodiment of the transponder of FIG. 3A; and

FIG. 5A and FIG. 5B schematically show in the form of a circuit block diagram an example of embodiment of the wireless communication system of FIG. 2, in two different charging states.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the RFID or NFC communication protocols and the usual electronic devices or circuits implementing these protocols have not been described in detail, these protocols being well known by those skilled in the art and being compatible with the described embodiments.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

In the following description, when reference is made to a radio frequency signal, it is referred to a signal supporting wireless communication, typically a signal having a frequency in the range from 3 kHz to 300 GHz, these frequencies being currently used for wireless communication.

In the following description, when reference is made to a battery charger, it is referred to a device configured to charge any power storage device, which comprises, but is not limited to, a battery. A battery charger may also be designated as a “charging circuit”.

FIG. 1 schematically shows in the form of a circuit block diagram an example of a wireless communication system 100, also supporting wireless charging.

System 100 comprises a first wireless communication device 110 and a second wireless communication device 120.

The first wireless communication device 110, which is for example configured to implement an NFC reader, comprises: a controller 111 (MCU1), which may be in the form of a microcontroller; a NFC reader 112 (READER), coupled, for example connected, to controller 111, and which may be in the form of an integrated circuit; and a first NFC antenna 113, coupled, for example connected, to NFC reader 112.

First NFC antenna 113 may comprise one or a plurality of coils or inductive elements, for example in the form of a patch antenna or of a microstrip antenna. The at least one coil or the at least one inductive element is, for example, connected to, or comprised in, an oscillating circuit (not shown in FIG. 1).

NFC reader 112 is, for example, configured to manage near-field communications via the first NFC antenna 113. For example, NFC reader 112 comprises: a circuit for supplying first NFC antenna 113 with AC current so that an electromagnetic field EMF can be emitted by said first antenna; a modulation and/or demodulation circuit configured to modulate and/or demodulate a radio frequency signal in order to receive data from, and/or send data to, the second wireless communication device 120, by using a NFC protocol.

NFC reader 112 may be connected or coupled to, or may comprise, an impedance matching circuit (not shown in FIG. 1), which is in turn connected or coupled to first antenna 113. NFC reader 112 may also comprise other electronic components (not shown in FIG. 1), well known by those skilled in the art.

Controller 111 is, for example, configured to implement a wireless communication protocol and to transmit an instruction signal to NFC reader 112. In return, NFC reader 112 may send information to controller 111.

Second wireless communication device 120, which is for example configured to implement or emulate a NFC card or transponder, comprises: a second NFC antenna 121, configured to be electromagnetically coupled to first NFC antenna 113; a NFC transponder 122 (TAG), coupled, for example connected, to second NFC antenna 121, and which may be in the form of an integrated circuit; a battery charger 123 (BATTERY CHARGER) coupled, for example connected, to second NFC antenna 121; a power storage device 124 (BATTERY) coupled, for example connected, to battery charger 123, the power storage device for example being a battery.

Second NFC antenna 121 may comprise one or a plurality of coils or inductive elements, for example in the form of a patch antenna or of a microstrip antenna. The at least one coil or the at least one inductive element is, for example, connected to, or comprised in, an oscillating circuit (not shown in FIG. 1).

NFC transponder 122 is, for example, configured to manage near-field communications. For example, NFC transponder 122 comprises a demodulation and/or modulation circuit configured to demodulate and/or modulate a radio frequency signal to receive data from, and/or send data to, the first wireless communication device 110, by using a NFC communication protocol.

In the example of FIG. 1, second NFC antenna 121 is also configured to manage an NFC charge. In other words, battery charger 123 is configured to receive an AC current induced by first NFC antenna 113 in second NFC antenna 121. Battery charger 123 can then supply a charge current to power storage device 124, for example to a battery. In return, power storage device 124 can send a signal to battery charger 123, for example to inform it of the charging state, such as a charge level. Battery charger 123 may comprise a plurality of electronic components (not shown in FIG. 1) for receiving the AC current, and, for example, convert it into a DC current.

NFC transponder 122 and/or battery charger 123 may be connected or coupled to, or may comprise, an impedance matching circuit (not shown in FIG. 1), which is in turn connected or coupled to second NFC antenna 121.

Although not shown in FIG. 1, the first wireless communication device 110 and the second wireless communication device 120 generally comprise other circuits and/or electronic components, well known by those skilled in the art.

In this example, second wireless communication device 120 comprises a microcontroller 125 (MCU2) having as a function, among other possible functions, to retrieve information relative to the charging state of power storage device 124 via battery charger 123, and, for example, to transmit this charging information to NFC transponder 122. Microcontroller 125 is thus configured to communicate with battery charger 123 and with NFC transponder 122. The charging information may be sent to the first wireless communication device 110 via NFC transponder 122 and second NFC antenna 121.

A drawback of using a microcontroller to manage an exchange of charging information between the second wireless communication device and the first wireless communication device is that this may require adding an electronic component, which consumes material, surface area, and electric power, which may increase the cost of manufacturing and system use.

If, conversely, no microcontroller is implanted, the first wireless communication device might have no information as to the charge level in the second wireless communication device, and thus, keep on transmitting power while this may not be necessary any longer.

Embodiment herein provide a wireless communication device which is configured to support wireless charging and which enables to overcome all or part of the previously-described drawbacks, in particular to address the charging information issue, while limiting electronic components, and their electric power consumption.

Embodiments of a wireless communication device will be described hereafter. The described embodiments are non-limiting and various alterations will occur to those skilled in the art based on the indications of the present disclosure.

It should be noted that, although the embodiments are more particularly described in relation with an NFC communication protocol, they more generally apply to any wireless communication protocol, for example of RFID type.

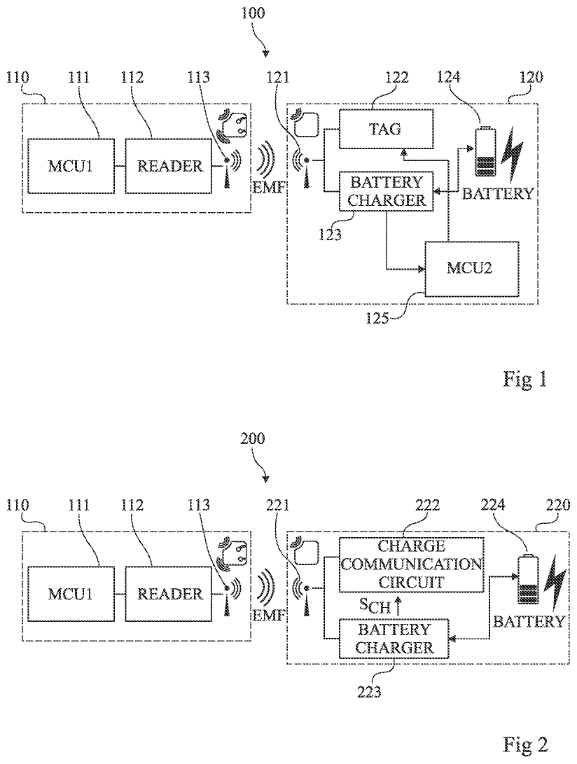

FIG. 2 schematically shows in the form of a circuit block diagram an example of a wireless communication system 200 comprising a wireless communication device 220 according to an embodiment.

System 200 comprises a first wireless communication device (other wireless communication device), for example similar to the first wireless communication device 110 of FIG. 1, and a second wireless communication device 220 (wireless communication device).

Second wireless communication device 220 comprises: a second NFC antenna 221 (NFC antenna), configured to be electromagnetically coupled to the first NFC antenna 113 of the first wireless communication device 110; a circuit 222 for communicating charging information (CHARGE COMMUNICATION CIRCUIT), coupled, for example connected, to second NFC antenna 221, and comprising a NFC transponder (not shown in FIG. 2); a battery charger 223 (BATTERY CHARGER), or charging circuit, coupled, for example connected, to second NFC antenna 221 and to communication circuit 222; a power storage device 224 (BATTERY) coupled, for example connected, to battery charger 223, the power storage device for example being a battery.

In the rest of the disclosure, the charging information communication circuit is also designated as a communication circuit.

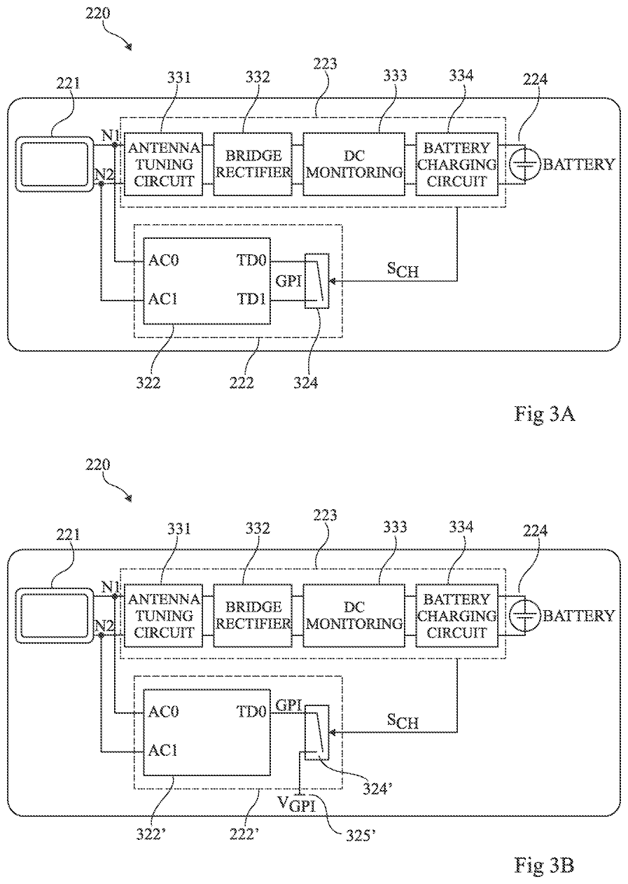

Similar to the second wireless communication device 120 of FIG. 1, the second wireless communication device 220 of FIG. 2, in particular the second NFC antenna 221, is also configured to manage a NFC charge. In other words, battery charger 223 is configured to receive an AC current induced by the first NFC antenna 113 (other NFC antenna) of the first wireless communication device 110 in the second NFC antenna 221. Battery charger 223 can then supply a charge current to power storage device 224. In return, power storage device 224 may send a signal to battery charger 223, for example to inform it of the charging level. Battery charger 223 may comprise a plurality of electronic components (not shown in FIG. 2, but given as an example in FIGS. 3A and 3B) for receiving the AC current, and, for example, convert it into a DC current.

The second wireless communication device 220 of FIG. 2 does not necessarily comprise a microcontroller similar to the microcontroller 125 of FIG. 1, and the NFC transponder comprised in communication circuit 220 comprises a terminal configured to be coupled to battery charger 223 via a switch comprised in communication circuit 222, as explained hereafter.

Battery charger 223 may send to communication circuit 222 a control signal SCH, and communication circuit 222 is configured to, according to the state of the sent control signal, communicate charging information to the first wireless communication device 110 via the NFC transponder of communication circuit 222, the second NFC antenna 221, and the first NFC antenna 121 of the first wireless communication device 110, and this, without it being necessary to have a microcontroller.

FIG. 3A schematically shows in the form of a circuit block diagram an example of an embodiment of the wireless communication device 220 of FIG. 2, including a wireless communication transponder.

FIG. 3A shows the following elements of wireless communication device 220 already described in relation with FIG. 2: NFC antenna 221; communication circuit 222 coupled, for example connected, to NFC antenna 221; battery charger 223 coupled, for example connected, to NFC antenna 221; power storage device 224 (BATTERY) coupled, for example connected, to battery charger 223.

Communication circuit 222 comprises an NFC transponder 322, for example in the form of an integrated circuit.

Similar to the NFC transponder 122 of FIG. 1, the NFC transponder 322 of FIG. 3A can be configured to manage near-field communications. For example, NFC transponder 322 comprises a demodulation and/or modulation circuit configured to demodulate and/or modulate a radio frequency signal to receive data from, and/or send data to, the first wireless communication device 110, by using an NFC communication protocol.

NFC transponder 322 is, for example, configured to process the information received from the first wireless communication device 110 and to retromodulate a carrier signal sent by the first wireless communication device 110 for the transmission of information, for example, charging information, to said first wireless communication device.

Communication circuit 222 further comprises a switch 324, coupled to at least one among two terminals TD0, TD1 of NFC transponder 322, and configured to couple, or opening the circuit between, the two terminals TD0 and TD1. As an alternative to a switch, it may be any other device configured to couple, or opening the circuit between, the two terminals TD0 and TD1.

The two terminals TD0, TD1 of NFC transponder 322 comprise an input terminal (TD0), preferably a digital terminal, from switch 324, for example forming a digital input (GPI), and an output terminal (TD1) towards switch 324.

NFC transponder 322 comprises two other terminals AC0, AC1, for example analog terminals, respectively coupled to two nodes N1, N2 at the output of NFC antenna 221.

For example, battery charger 223, or charging circuit, comprises: an impedance matching circuit 331 (ANTENNA TUNING CIRCUIT) coupled, for example connected, to the two nodes N1, N2 at the output of NFC antenna 221; a rectifier 332 (BRIDGE RECTIFIER) coupled, for example connected, to impedance matching circuit 331; a DC current monitoring circuit 333 (DC MONITORING) coupled, for example connected, to rectifier 332, and configured to detect the presence of a DC voltage, and/or of a DC current, at the output of rectifier 332 and, as a response, to powering a charging circuit; and a charging circuit 334 (BATTERY CHARGING CIRCUIT) coupled, for example connected, to DC current monitoring circuit 333, and configured to transmit the detected DC voltage and/or the detected DC current to power storage device 224.

The two terminals TD0, TD1 of NFC transponder 322 are coupled to battery charger 223, in the example to charging circuit 334, via switch 324, when the latter is on. When the switch is off, a single terminal TD0 among the two terminals TD0, TD1 of NFC transponder 322 is coupled to battery charger 223.

By sending a control signal SCH to switch 324, indicating a charging information, for example a charging state, of power storage device 224, battery charger 223, for example charging circuit 334, may trigger a connection (closing of the circuit) between the two terminals TD0 and TD1, or an opening of the circuit between the two terminals TD0 and TD1. NFC transponder 322 is configured to detect the state of switch 324, according to the state of the circuit (open or closed) between the two terminals TD0, TD1. NFC transponder 322 can thus determine the control signal SCH sent by battery charger 223, and thus trace back the charging information.

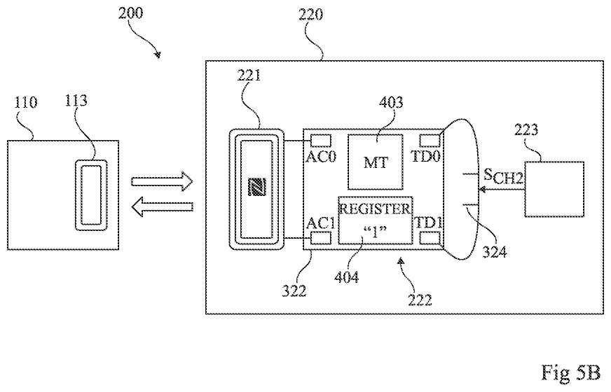

Thus, as explained hereafter in relation with FIGS. 5A and 5B, battery charger 223, for example charging circuit 334, may, according to the charging state of power storage device 224, send a control signal SCH intended to turn off or turn on switch 324, and NFC transponder 322 can detect the state of switch 324.

According to an example, the two terminals TD0, TD1 are digital terminals of an NFC transponder used for an event detection, and these terminals are also used to detect the state of the switch. For example, the event detection function is a tamper detect function.

FIG. 3B schematically shows in the form of a circuit block diagram another example of embodiment of the wireless communication device of FIG. 2, including another wireless communication transponder. The wireless communication device of FIG. 3B differs from that of FIG. 3A in that NFC transponder 322′ no longer comprises two terminals TD0, TD1 but a single terminal TD0 (first terminal), for example forming a digital input (GPI), and communication circuit 222′ comprises a node 325′ of application of a voltage V_{GPI}, which may be either the ground, or a positive voltage. The switch 324′ of communication circuit 222′ is configured to couple the terminal TD0 of NFC transponder 322′ to the node 325′ of application of voltage V_{GPI}, or to opening the circuit between terminal TD0 and node 325′. As an alternative to a switch, it may be any other device configured to couple, or opening, the circuit between terminal TD0 and node 325′.

In the case where voltage V_{GPI} is a positive voltage, for example at V_{DD}, NFC transponder 322′ comprises for example a resistor coupling terminal TD0 to ground.

In the case where voltage V_{GPI} is the ground, NFC transponder 322′ comprises for example a resistor coupling terminal TD0 to a positive voltage, for example to V_{DD}.

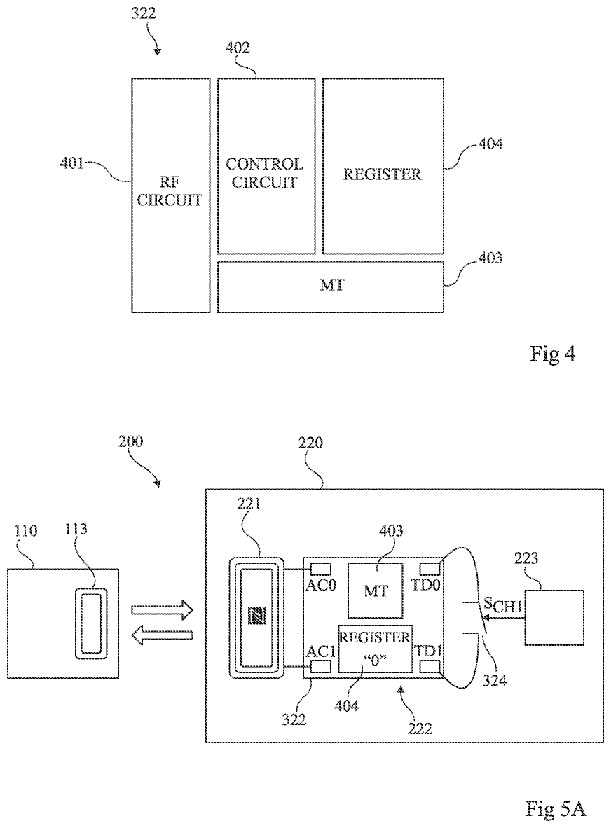

FIG. 4 schematically shows in the form of a circuit block diagram an example of embodiment of the NFC transponder 322 of FIG. 3A.

In addition to conventional electronic components of an NFC transponder, such as an RF modulation/demodulation circuit 401 (RF CIRCUIT), and a control circuit 402 (CONTROL CIRCUIT) configured to implement a wireless communication protocol NFC and transmit an instruction signal to RF circuit 401, NFC transponder 322 comprises a processing unit 403 (MT) configured to detect whether the two terminals TD0, TD1 are coupled or not, corresponding to a charging information, as explained hereafter.

Processing unit 403 may comprise a circuit configured to deliver a reference voltage into one of the two terminals TD0, TD1, for example the second terminal TD1, and to measuring a voltage in another of the two terminals TD0, TD1, for example the first terminal TD0.

Processing unit 403 may also comprise, for example, comparison means configured to compare the voltage measured at the first terminal TD0 with the reference voltage present at the second terminal TD1 to detect whether the two terminals TD0, TD1 are coupled or not by switch 324.

For example, if the two terminals TD0, TD1 are not coupled, the voltage on first terminal TD0 is close to, or equal to, the ground voltage, for example approximately zero, resulting in the delivery of a first binary value, for example a “0”, for example at the output of the comparator. If, however, the two terminals TD0, TD1 are coupled, the voltage present on first terminal TD0 depends on the reference voltage, and generally on the resistance of the switch and on a pull-down resistor coupled between first terminal TD0 and the ground. The switch and pull-down resistances being generally fixed, the reference voltage may be selected so that the voltage detected on first terminal TD0 is in a range of values resulting in the delivery of a second binary value, for example a “1”, for example at the comparator output.

As a variant, it is possible to detect whether the two terminals TD0, TD1 are coupled, or not, by injecting a current into one of the terminals and by detecting the presence or the absence of this current in the other terminal.

NFC transponder 322 may further comprise a storage unit 404 (REGISTER) configured to store information, for example charging information. Storage unit 404 may be a register, or a memory, for example a memory of electrically erasable programmable read-only memory type, or EEPROM.

NFC transponder 322 is also configured to transmit the charging information to the first wireless communication device 110, via the NFC antenna 221 of wireless communication device 220 and the NFC antenna 113 of first wireless communication device 110, as explained hereafter in relation with FIGS. 5A and 5B.

The example of embodiment of FIG. 4 has been described in relation with the NFC transponder 322 of FIG. 3A, but may also apply to the NFC transponder 322′ of FIG. 3B. In this case, processing unit 403 is configured to detect whether terminal TD0 and node 325′ are coupled or not, corresponding to charging information. Processing unit 403 may comprise a circuit configured to measure a voltage in terminal TD0, and comparison means configured to compare the voltage measured at terminal TD0 with the voltage V_{GPI} present at node 325′ (replacing the reference voltage at the second terminal TD1), to detect whether terminal TD0 and node 325′ are coupled or not by switch 324′.

FIG. 5A and FIG. 5B schematically show in the form of a circuit block diagram an example of embodiment of the wireless communication system 200 of FIG. 2, in two different charging states.

The battery charger 223 of wireless communication device 220, for example the charging circuit 334 of FIG. 3A, may send a control signal having a first state S_{CH1} to communication circuit 222 intended to position, or to maintain, switch 324 in an off state, corresponding to opening, or to maintaining open, the circuit between the two terminals TD0 and TD1, as shown in FIG. 5A.

The battery charger 223 of wireless communication device 220, for example the charging circuit 334 of FIG. 3A, can send a control signal having a second state S_{CH2} to communication circuit 222 intended to position, or to hold, switch 324 in an on state, amounting to coupling, or to maintaining the connection between, the two terminals TD0 and TD1, as shown in FIG. 5B.

For example, the first state S_{CH1} of the control signal corresponds to a first charging state of the power storage device, for example a non-completed charging state, and the second state S_{CH2} of the control signal corresponds to a second charging state of the power storage device, for example a completed charging state.

For example, if the two terminals TD0 and TD1 are not coupled, then the processing unit 403 of NFC transponder 322 may assign a first binary value, for example value “0”, to the charging information which is representative of a first charging state of the power storage device, for example a non-completed charging. The storage unit 404 of NFC transponder 322 can then store this first binary value “0”. If, however, the two terminals TD0 and TD1 are coupled, processing unit 403 can assign a second binary value, for example value “1”, to the charging information which is representative of a second charging state of the power storage device, for example a completed charging. Storage unit 404 can then store this second binary value “1”.

Then, the charging information can be delivered by the NFC transponder 322 of communication circuit 222 to the first wireless communication device 110 during a wireless communication. For example, the first wireless communication device 110 interrogates NFC transponder 322 and the latter, for example by retromodulation, delivers the value of the charging information to the first wireless communication device 110.

The example of embodiment of FIGS. 5A and 5B has been described in relation with the wireless communication device of FIG. 3A, but may also apply to the wireless communication device of FIG. 3B. In this case, the control signal sent by battery charger 223, for example charging circuit 334, is intended to position, or to maintain, switch 324 in an off state, respectively in an on state, corresponding to opening or to maintaining open, respectively to closing or to maintaining closed, the circuit between terminal TD0 and the node 325′ of application of voltage V_{GPI}, and processing unit 403 is configured to detect whether terminal TD0 and node 325′ are coupled or not.

Thus, the embodiments enable to manage the wireless charging of a wireless communication device, for example to transmit information relative to the charging in the wireless communication device to another (first) wireless communication device which transfers the charge thereto, for example by communication of NFC or RFID type, without it being necessary to have a microcontroller.

In the described embodiments, power storage device 224, for example the battery, may be used for the specific needs of wireless communication device 220, for example of NFC transponder 322, and/or to charge an object coupled to, integrated in, or integrating, wireless communication device 220. The object may be a pair of headphones, a connected watch, a fitness tracker, or any object of connected object type or of Internet of things type (IoT).

Various embodiments and variants have been described. Those skilled in the art will understand that certain features of these various embodiments and variants may be combined, and other variants will occur to those skilled in the art. In particular, the wireless communication transponder may be an RFID transponder using an NFC technology, an RFID technology, or another wireless communication technology.

Finally, the practical implementation of the described embodiments and variants is within the abilities of those skilled in the art based on the functional indications given hereabove.

1. A wireless communication device configured to receive power in wireless fashion from another wireless communication device, the wireless communication device comprising:
a charging circuit configured to charge a power storage device; and
a communication circuit comprising:
a wireless communication transponder; and
a switch coupled to a first terminal of the wireless communication transponder, wherein an open and closed state of the switch is controlled by the charging circuit to communicate charging information to the other wireless communication device, said charging information indicative of the charging of the power storage device.

2. The device according to claim 1, wherein the closed state of the switch is configured to couple the first terminal to a node of application of a voltage, said node being included in the communication circuit, and wherein the open state of the switch is configured to not couple the first terminal to the node of application of the voltage, and wherein the switch is controlled by a control signal output by the charging circuit, said control signal corresponding to the charging information.

3. The device according to claim 1, wherein the closed state of the switch is configured to couple the first terminal to a second terminal of the transponder, and wherein the open state of the switch is configured to not couple the first terminal to the second terminal of the transponder, and wherein the switch is controlled by a control signal output by the charging circuit, said control signal corresponding to the charging information.

4. The device according to claim 3, wherein the wireless communication transponder of the communication circuit is configured to detect whether the first and second terminals are coupled or not coupled, and to transmit the corresponding charging information to the other wireless communication device.

5. The device according to claim 3, wherein the switch couples or does not couple the first and second terminals in respond to a control signal output by the charging circuit.

6. The device according to claim 3, wherein the charging circuit is configured to control the switch to couple the first and second terminals when the power storage device changes from a first charging state to a second charging state, and to control the switch to not couple the first and second terminals when the power storage device changes from the second charging state to the first charging state.

7. The device according to claim 3, wherein the charging circuit controls the switch with a control signal having:
a first signal state indicating a first charging state of the power storage device, the first signal state configured to trigger, or maintain, the not coupling of the first and second terminals by the switch; and
a second signal state indicating a second charging state of the power storage device, the second signal state configured to trigger, or maintain, the coupling of the first and second terminals by the switch.

8. The device according to claim 6, wherein the first charging state is a non-completed charging state, and the second charging state is a completed charging state.

9. The device according to claim 3, wherein the wireless communication transponder comprises a processing circuit configured to detect whether the first and second terminals are coupled or not coupled.

10. The device according to claim 9, wherein the processing circuit is configured to measure a voltage at the first terminal and to deliver a reference voltage to the second terminal.

11. The device according to claim 10, wherein the processing circuit includes a comparison circuit configured to compare the voltage measured at the first terminal with the reference voltage, and from the comparison detect whether the first and second terminals are coupled or not coupled.

12. The device according to claim 1, wherein the charging information takes the form of a binary value.

13. The device according to claim 1, wherein the wireless communication transponder comprises a storage circuit configured to store the charging information.

14. The device according to claim 1, wherein the first terminal is an input terminal of the wireless communication transponder.

15. The device according to claim 1, wherein the power storage device is a battery.

16. The device according to claim 1, wherein the power storage device is used for the wireless communication device.

17. The device according to claim 1, wherein the power storage device is used to charge an object coupled to the wireless communication device.

18. The device according to claim 1, wherein the wireless communication transponder is in the form of an integrated circuit.

19. The device according to claim 1, further comprising a wireless communication antenna coupled to the wireless communication transponder and configured to transmit the charging information by electromagnetic coupling with another wireless communication antenna of the other wireless communication device, the charging circuit being also coupled to the wireless communication antenna.

20. The device according to claim 1, wherein the wireless communication transponder is one of an NFC transponder and an RFID transponder using an NFC technology.

21. The device according to claim 1, wherein the switch is configured, in response to a control signal generated by the charging circuit and which corresponds to the charging information, to apply an open and closed state, and the wireless communication transponder is configured to detect the open and closed state in order to communicate the charging information to other wireless communication device.

22. A method of communication of a charging information relative to the charging of a power storage device comprised in a wireless communication device configured to receive power in wireless fashion from another wireless communication device;
wherein the wireless communication device comprises:
a charging circuit configured to charge the power storage device; and
a communication circuit comprising: a wireless communication transponder; and a switch coupled to a first terminal of the transponder, and controlled by the charging circuit;
the method comprising:
detecting, by the communication circuit, the open and closed state of the switch; and
transmitting, by the communication circuit, of the corresponding charging information to the other wireless communication device in response to the detected open and closed state.

23. The method according to claim 22, wherein the detection and the transmission is performed by the wireless communication transponder.

24. The method according to claim 22, further comprising, before detecting:
sending a control signal from the charging circuit to the switch, said control signal corresponding to the charging information, and wherein the open and closed state of the switch is controlled by said control signal.
